(19) United States
(12) Patent Application Publication
(10) Pub. No.: US 2026/0027815 A1
(43) Pub. Date: Jan. 29, 2026

(54) TEXTILE FABRIC

(71) Applicant: JHIH HUEI TRADING CO., LTD., CHANGHUA COUNTY (TW)

(72) Inventor: YUNG-YU WU, Changhua County (TW)

(21) Appl. No.: 18/783,880

(22) Filed: Jul. 25, 2024

(51) Int. Cl. B32B 27/12; B32B 3/26; B32B 3/30; B32B 5/02; B32B 27/30; B32B 27/40

(52) U.S. Cl. CPC B32B 27/12; B32B 3/30; B32B 5/024; B32B 27/304; B32B 27/40; B32B 2307/406; B32B 2307/408; B32B 2307/538; B32B 2307/724; B32B 2307/7265; B32B 2307/7376

(57) ABSTRACT

A textile fabric is provided, including: a main body and a film layer. The main body includes two surfaces opposite to each other, and the film layer is coveringly disposed on one of the two surfaces. A side of the film layer opposite to the main body includes at least one first surface portion and at least one second surface portion, and a glossiness of the at least one first surface portion is different from a glossiness of the at least one second surface portion.

### BACKGROUND OF THE INVENTION

### Field of the Invention

The present invention relates to a textile fabric.

### Description of the Prior Art

Textile fabrics are made by a plurality of yarns through different techniques such as knitting and weaving, and they are widely used in daily life including clothing, shoe uppers, bags, etc. To achieve waterproof and toughening effects, surfaces of the textile fabrics may be coated with a waterproof coating, or the plurality of yarns may be covered with a waterproof coating before weaving.

However, the meshes of the textile fabric may be covered by the waterproof coating on the surfaces, which results in poor softness and poor appearance of the textile fabric, and easy peeling of the waterproof coating. The plurality of yarns with the waterproof coating may have poor flexibility and high frictional resistance, which is inconvenient to weaving and provides poor tactile feel of the textile fabric. In addition, the textile fabric with the waterproof coating has an appearance based on the color or material of the waterproof coating, which results in poor appearance variability of the textile fabric.

The present invention is, therefore, arisen to obviate or at least mitigate the above-mentioned disadvantages.

### SUMMARY OF THE INVENTION

The main object of the present invention is to provide a textile fabric, which is waterproof and has special appearance.

To achieve the above and other objects, the present invention provides a textile fabric, including: a main body and a film layer. The main body includes two surfaces opposite to each other. The film layer is coveringly disposed on one of the two surfaces, and a side of the film layer opposite to the main body includes at least one first face portion and at least one second face portion. A glossiness of the at least one first face portion is different from a glossiness of the at least one second face portion.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a side view of a preferable embodiment of the present invention;

FIG. 2 is a partial cross-sectional view of a preferable embodiment of the present invention;

### DETAILED DESCRIPTION OF THE PREFERRED EMBODIMENTS

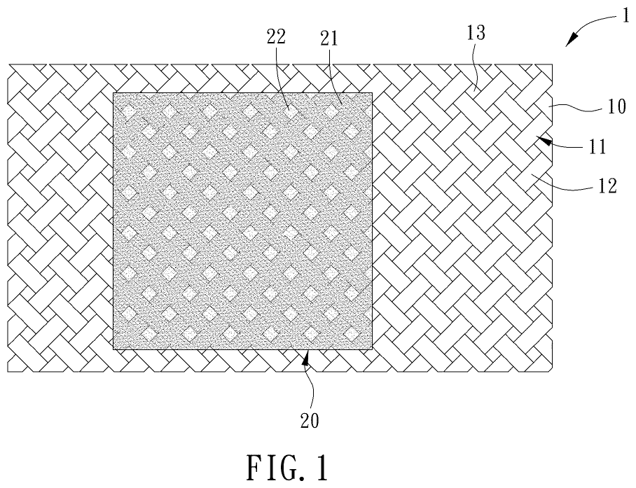

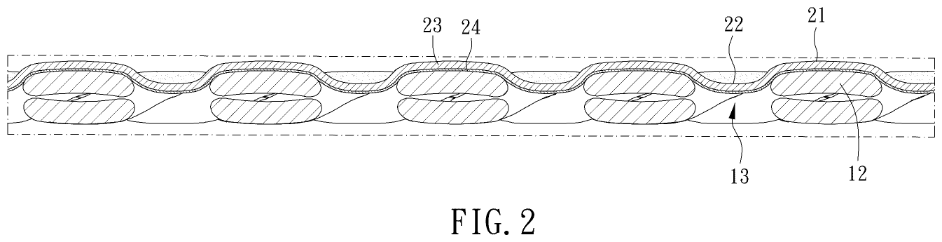

Please refer to FIGS. 1 to 2 for a preferable embodiment of the present invention. A textile fabric 1 of the present invention includes a main body 10 and a film layer 20.

The main body 10 includes two surfaces 11 opposite to each other. The film layer 20 is coveringly disposed on one of the two surfaces 11, and a side of the film layer 20 opposite to the main body 10 includes at least one first face portion 21 and at least one second face portion 22. A glossiness of the at least one first face portion 21 is different from a glossiness of the at least one second face portion 22. Therefore, the textile fabric 1 has good toughness and is waterproof and not easy to be damaged, and the at least one first face portion 21 and the at least one second face portion 22 have different glossiness so that a surface of the film layer 20 exposed outwardly provides special visual effect.

The film layer 20 is made of a material including at least one of polyurethane and polyvinyl chloride, and a thickness of the film layer 20 is between 20 μm and 450 μm. Therefore, the film layer 20 can increase structural strength of the textile fabric 1, and the appropriate thickness of the film layer 20 avoids reducing the flexibility of the textile fabric 1 and provides good adhesion so as to be not easy to peel off. In this embodiments, the film layer 20 is made of a material including polyurethane and is a waterproof breathable film layer so as to advantages of wear-resistant, good toughness, environmentally friendly and decomposable. Furthermore, the film layer 20 includes a film material layer 23 and a connecting layer 24, and the connecting layer 24 is disposed on a side of the film material layer 23 and connected with one of the two surfaces 11. A thickness of the film material layer 23 is larger than or equal to 0.1 mm. Preferably, a thickness of the connecting layer 24 is smaller than or equal to the thickness of the film material layer 23, which facilitates connection between the film layer 20 and the main body 10. The film material layer 23 is light non-permeable, and the thickness of the film layer 20 is between 200 μm and 400 μm, which allows the at least one first face portion 21 and the at least one second face portion 22 have obvious contrast in glossiness so as to have preferable visual effect.

A material of the connecting layer 24 is preferably different from a material of the film material layer 23, for example, the film material layer 23 may be made of thermoplastic polyurethane, and the connecting layer 24 may be made of a material that has preferable bonding strength with the main body 10 for stable connection. The film material layer 23 is preferably integrated with the connecting layer 24 in advance. For example, the connecting layer 24 may be partially or completely pre-coated, spayed or filmed on a side of the film material layer 23, so that the film layer 20 is convenient to be used during processing.

Specifically, the at least one first face portion 21 is arranged around the at least one second face portion 22 and integrally and continuously connected with the at least one second face portion 22. The main body 10 further includes a plurality of yarns 12, and the at least one first face portion 21 covers and extends on the plurality of yarns 12. The main body 10 includes a plurality of holes 13, and the at least one second face portion 22 is recessed within the plurality of holes 13. Therefore, the at least one first face portion 21 and the at least one second face portion 22 are non-coplanar and adjacently connected with each other, having different glossiness to provide special visual effect. In this embodiment, a diametrical dimension of each of the plurality of holes 13 is larger than or equal to 2 mm and each of the plurality of holes 13 is preferably a through hole so that the film layer 20 is obviously recessed into the plurality of holes 13 and the surface of the film layer 20 has obvious concave and convex effect. A surface roughness of each of the at least one first face portion 21 is larger than a surface roughness of each of the at least one second face portion 22. The glossiness of the at least one first face portion 21 is smaller than the glossiness of the at least one second face portion 22; each of the at least one first face portion 21 is a matte surface, and each of the at least one second face portion 22 is a glossy surface. In other words, portions of the film layer 20 corresponding to the plurality of holes 13 of the main body 10 are glossy surfaces, and portions of the film layer 20 corresponding to the plurality of yarns 12 are matte surfaces, which allows concave portions and convex portions of the surface texture to have obvious visual contrast. In other embodiments, the glossiness of each of the at least one first face portion may be larger than the glossiness of each of the at least one second face portion.

During manufacturing, the main body 10 and the film layer 20 are stacked on a platform with a plurality of suction holes in sequence, and a release member (such as silicone membrane, rubber membrane, rigid plate, etc.) is provided on the film layer 20. A side of the release member has a rough surface configured to contact the film layer 20. Air is extracted through the plurality of suction holes and a hot plate is pressed on a side of the release member opposite to the film layer 20. As a result, the film layer 20 is soften by heat and attached to the main body 10, and the film layer 20 is recessed within the plurality of holes 13, providing an appearance convex and concave corresponding to the surface texture of one of the two surfaces 11. Moreover, the rough surface of the release member provides said matte surfaces on the film layer 20, which is easy to be manufactured and provides special visual effect.

In summary, the film layer 20 of the present invention covers the plurality of holes 13 to achieve waterproof, breathable and anti-slip effects, and the plurality of yarns 12 are held in place by the film layer 20 so that the textile fabric 1 has excellent tensile strength and maintains good flexibility. In addition, a color of the film layer 20 is changeable to provide various appearances, and the film layer 20 provides said matte surfaces and said glossy surfaces corresponding to the surface texture of at least one of the two surfaces 11, providing special visual effect.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A textile fabric, including:
a main body, including two surfaces opposite to each other; and
a film layer, coveringly disposed on one of the two surfaces, a side of the film layer opposite to the main body including at least one first face portion and at least one second face portion, a glossiness of the at least one first face portion being different from a glossiness of the at least one second face portion.

2. The textile fabric of claim 1, wherein the film layer is made of a material including at least one of polyurethane and polyvinyl chloride.

3. The textile fabric of claim 1, wherein the film layer includes a film material layer and a connecting layer, the connecting layer is disposed on a side of the film material layer and connected with one of the two surfaces, and a thickness of the film material layer is larger than or equal to 0.1 mm.

4. The textile fabric of claim 3, wherein the film material layer is light non-permeable, and a thickness of the film layer is between 20 μm and 450 μm.

5. The textile fabric of claim 1, wherein a surface roughness of each of the at least one first face portion is larger than a surface roughness of each of the at least one second face portion.

6. The textile fabric of claim 1, wherein the at least one first face portion is arranged around the at least one second face portion.

7. The textile fabric of claim 1, wherein the main body includes a plurality of holes, and the at least one second face portion is recessed within the plurality of holes.

8. The textile fabric of claim 7, wherein the glossiness of the at least one first face portion is smaller than the glossiness of the at least one second face portion.

9. The textile fabric of claim 7, wherein each of the at least one first face portion is a matte surface, and each of the at least one second face portion is a glossy surface.

10. The textile fabric of claim 4, wherein the film layer is made of a material including polyurethane and is a waterproof breathable film layer; a material of the connecting layer is different from a material of the film material layer; the thickness of the film layer is between 200 μm and 400 μm; a surface roughness of each of the at least one first face portion is larger than a surface roughness of each of the at least one second face portion; the at least one first face portion is arranged around the at least one second face portion and integrally and continuously connected with the at least one second face portion; the main body includes a plurality of holes, the at least one second face portion is recessed with the plurality of holes; a diametrical dimension of each of the plurality of holes is larger than or equal to 2 mm; the glossiness of the at least one first face portion is smaller than the glossiness of the at least one second face portion; each of the at least one first face portion is a matte surface, and each of the at least one second face portion is a glossy surface; each of the two surfaces has a surface texture being concave and convex, the film layer is concave and convex corresponding to one said surface texture; and the main body further includes a plurality of yarns, and the at least one first face portion covers and extends on the plurality of yarns.
